(19) United States
(12) Patent Application Publication
(10) Pub. No.: US 2023/0286394 A1
(43) Pub. Date: Sep. 14, 2023

(54) DRIVE UNIT

(71) Applicant: EXEDY Corporation, Osaka (JP)

(72) Inventor: Yoshihiro MATSUOKA, Osaka (JP)

(21) Appl. No.: 18/166,191

(22) Filed: Feb. 8, 2023

(30) Foreign Application Priority Data
Mar. 8, 2022 (JP) 2022-035308

(51) Int. Cl. B60L 15/20; F16H 3/089; B60K 17/08; B60K 17/02; B60Q 5/00

(52) U.S. Cl. CPC B60L 15/20; F16H 3/089; B60K 17/08; B60K 17/02; B60Q 5/005; B60L 2240/486

(57) ABSTRACT

A drive unit includes an electric motor and a transmission. The electric motor exerts characteristics that a maximum torque (N·m) is less in magnitude than or equal in magnitude to two times a maximum output (kW). The transmission is configured to change a rotational speed of the electric motor at variable gear ratios.

### CROSS-REFERENCE TO RELATED APPLICATIONS

This application claims priority to Japanese Patent Application No. 2022-035308 filed Mar. 8, 2022. The entire contents of that application are incorporated by reference herein in their entirety.

### TECHNICAL FIELD

The present invention relates to a drive unit.

### BACKGROUND ART

In recent years, electric cars, including an electric motor as a drive source, have been attracted as a transportation option without emission of carbon dioxide. Such an electric car includes the electric motor as the only drive source thereof without including an internal combustion engine. The electric motor does not include a transmission because of the ability thereof to generate the maximum torque even at a low rotational speed (e.g., Japan Laid-open Patent Application Publication No. 2013-159306).

A large-sized truck or so forth has a drawback of insufficient drive performance when designed to include the electric motor as the only drive source thereof. In view of this, it is an object of the present invention to provide a drive unit by which a sufficient drive performance can be obtained.

### BRIEF SUMMARY

A drive unit according to an aspect of the present invention includes an electric motor and a transmission. The electric motor exerts characteristics that a maximum torque (N·m) is less in magnitude than or equal in magnitude to two times a maximum output (kW). The transmission is configured to change a rotational speed of the electric motor at variable gear ratios.

According to this configuration, a drive force generated by the electric motor is outputted, while being changed in speed by the transmission; hence, a sufficient drive performance can be obtained. It should be noted that an electric motor to be used for a normal electric car exerts characteristics that the maximum torque (N·m) is greater in magnitude than or equal in magnitude to triple the maximum output (kW); hence, a large load acts on a transmission in the normal electric car. By contrast, the electric motor according to the present invention exerts the characteristics that the maximum torque (N·m) is greater in magnitude than or equal in magnitude to two times the maximum output (kW). Because of this, the load acting on the transmission can be reduced, whereby a transmission to be used for a conventional internal combustion engine-equipped car is made usable as the transmission in the drive unit of the present invention.

Preferably, the drive unit further includes a clutch. The clutch is configured to transmit a mechanical power of the electric motor to the transmission but is capable of blocking the mechanical power from being transmitted to the transmission.

Preferably, the clutch is a dry clutch.

Preferably, the clutch is of a solid type.

Preferably, the electric motor has a maximum rotational speed of less than or equal to 6000 rpm.

Preferably, the transmission has a gear ratio coverage of greater than or equal to 2.

Preferably, the transmission includes three or more gear trains.

Preferably, the drive unit further includes a controller. The controller is configured to control the electric motor. The controller reversely rotates the electric motor in rearward traveling when determining that a gear train having a largest gear ratio is being selected among the three or more gear trains.

Preferably, the drive unit further includes an electronic sound producing device producing a sound in accordance with the rotational speed of the electric motor.

Preferably, the drive unit further includes a sound producing member producing a sound when the electric motor is rotated.

Overall, according to the present invention, a sufficient drive performance can be obtained by an electric motor even when the maximum torque, exerted by the electric motor, is small in magnitude.

### BRIEF DESCRIPTION OF THE DRAWINGS

FIG. 1 is a block diagram of a drive unit.

FIG. 2 is a schematic diagram of a transmission.

FIG. 3 is a flowchart showing a control method executed in rearward movement.

FIG. 4 is a chart showing a relation between rotational speed and torque in an electric motor.

FIG. 5 is a chart showing a relation between rotational speed and torque in a drive unit.

FIG. 6 is a schematic diagram of a transmission according to a modification.

### DETAILED DESCRIPTION

A drive unit according to the present preferred embodiment will be hereinafter explained with reference to drawings.

### [Drive Unit]

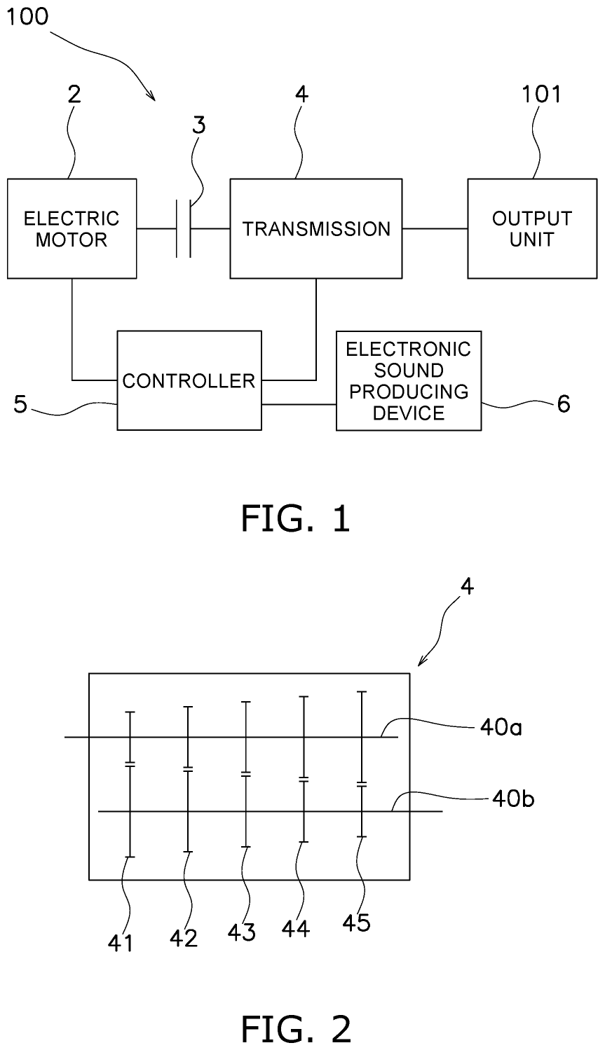

As shown in FIG. 1, a drive unit 100 includes an electric motor 2, a clutch 3, a transmission 4, a controller 5, and an electronic sound producing device 6. The drive unit 100 is configured to output a torque to an output unit 101. The drive unit 100 is installed in, for instance, an electric car.

### [Electric Motor]

The electric motor 2 is used as a drive source. It should be noted that the drive unit 100 does not include an engine as the drive source thereof. In other words, the electric motor 2 is the only drive source of the drive unit 100. The electric motor 2 is driven when electrified by a battery (not shown in the drawings).

The electric motor 2 is forwardly and reversely rotated. When the electric motor 2 is forwardly rotated, the drive unit 100 causes the electric car to travel forward. By contrast, when the electric motor 2 is reversely rotated, the drive unit 100 causes the electric car to travel rearward.

The electric motor 2 exerts characteristics that the maximum torque (N·m) is less in magnitude than or equal in magnitude to two times the maximum output (kW). For example, when the maximum output of the electric motor 2 is 100 kW, the maximum torque thereof is preferably greater than or equal to 150 N·m and less than or equal to 200 N·m. The electric motor 2 has the maximum rotational speed of less than or equal to 6000 rpm.

### [Clutch]

The clutch 3 is configured to transmit a mechanical power of the electric motor 2 to the transmission 4 but is capable of blocking the mechanical power from being transmitted thereto. When turned to a clutch-on state, the clutch 3 transmits the mechanical power of the electric motor 2 to the transmission 4. By contrast, when turned to a clutch-off state, the clutch 3 does not transmit the mechanical power of the electric motor 2 to the transmission 4. The clutch 3 is, for instance, a dry clutch. Besides, the clutch 3 is of a solid type. In other words, the clutch 3 is configured not to cause torsion in a rotational direction. Specifically, the clutch 3 does not have a damper function.

### [Transmission]

The transmission 4 is configured to change the rotational speed of the electric motor 2 at variable gear ratios. For example, the transmission 4 is a manual transmission.

As shown in FIG. 2, the transmission 4 includes an input shaft 40a and an output shaft 40b. The input shaft 40a receives an input of the mechanical power outputted from the electric motor 2. The output shaft 40b outputs the mechanical power to the output unit 101.

Besides, the transmission 4 includes three or more gear trains. It should be noted that in the present preferred embodiment, the transmission 4 includes five gear trains. Specifically, the transmission 4 includes first to fifth gear trains 41 to 45. Each of the first to fifth gear trains 41 to 45 includes a plurality of gears (e.g., a pair of gears).

The transmission 4 transmits the mechanical power of the electric motor 2 to the output unit 101 through any of the first to fifth gear trains 41 to 45. Thus, the transmission 4 is capable of selecting any of the first to fifth gear trains 41 to 45, and therefore, has variable gear ratios.

The gear ratios of the first to fifth gear trains 41 to 45 descends in magnitude in the order of the first gear train 41, the second gear train 42, the third gear train 43, the fourth gear train 44, and the fifth gear train 45. In other words, the gear ratio of the first gear train 41 is the largest, whereas that of the fifth gear train 45 is the smallest. The transmission 4 has a gear ratio coverage of greater than or equal to 2. In other words, when the gear ratio of the first gear train 41 is divided by that of the fifth gear train 45, the resultant value is greater than or equal to 2. It should be noted that the first to fifth gear trains 41 to 45 are forward-rotation gear trains. When the electric motor 2 is rotated forward, the vehicle travels forward by the drive force outputted through any of the first to fifth gear trains 41 to 45.

### [Controller]

The controller 5 is configured to control the electric motor 2. For example, a computer (e.g., microcomputer), including a CPU (Central Processing Unit), a ROM (Read Only Memory), and so forth, is provided as the controller 5. The ROM stores programs for various computations. The CPU executes the programs stored in the ROM.

The controller 5 reversely rotate the electric motor 2 in rearward traveling. Then, the controller 5 transmits the mechanical power of the electric motor 2 through the first gear train 41, the gear ratio of which is the largest among those of the first to fifth gear trains 41 to 45.

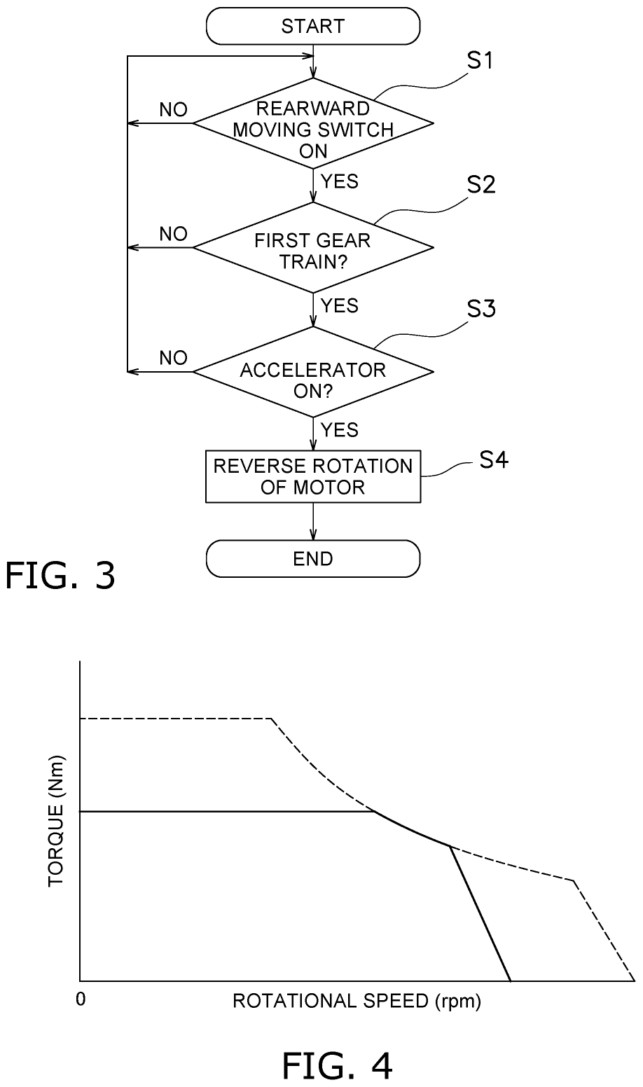

FIG. 3 is a flowchart showing an exemplary control method executed by the controller 5. As shown in FIG. 3, the controller 5 firstly determines whether or not a rearward moving switch has been operated by a driver (step S1). It should be noted that for example, a button switch, a touchscreen, or so forth can be provided as the rearward moving switch.

When determining that the rearward moving switch has been operated (Yes in step S1), the controller 5 then determines whether or not the first gear train 41, the gear ratio of which is the largest among those of the first to fifth gear trains 41 to 45 in the transmission 4, is being selected (step S2).

When determining that the first gear train 41 is being selected (Yes in step S2), the controller 5 then determines whether or not an accelerator is being pressed down (step S3). For example, the controller 5 determines whether or not the accelerator is being pressed down based on an accelerator opening degree or so forth.

When determining that the accelerator is being pressed down (Yes in step S3), the controller 5 reversely rotates the electric motor 2 (step S4). As a result, the vehicle travels rearward.

### [Electronic Sound Producing Device]

The electronic sound producing device 6 generates a sound in accordance with the rotational speed of the electric motor 2. For example, the controller 5 controls and causes the electronic sound producing device 6 to produce a sound in accordance with the rotational speed of the electric motor 2. The electronic sound producing device 6 is capable of increasing the pitch or volume of the sound to be produced therefrom with increase in rotational speed of the electric motor 2. It should be noted that the electronic sound producing device 6 outputs the sound to the interior of a cab of the vehicle so as to make the sound audible to the driver of the vehicle.

### [Various Characteristics]

FIG. 4 is a chart showing a relation between rotational speed and torque in the electric motor. In FIG. 4, a broken line indicates the characteristics of an electric motor to be used for a conventional electric car, whereas a solid line indicates the characteristics of the electric motor 2 to be used for the drive unit 100 according to the present preferred embodiment. As shown in FIG. 4, the electric motor 2 in the drive unit 100 is narrower in actuation range than the electric motor to be used for the conventional electric car. In other words, the electric motor 2 is lower in maximum rotational speed than the electric motor in the conventional electric car. Besides, when identical in output to the electric motor in the conventional electric car, the electric motor 2 is smaller in maximum torque than the electric motor in the conventional electric car.

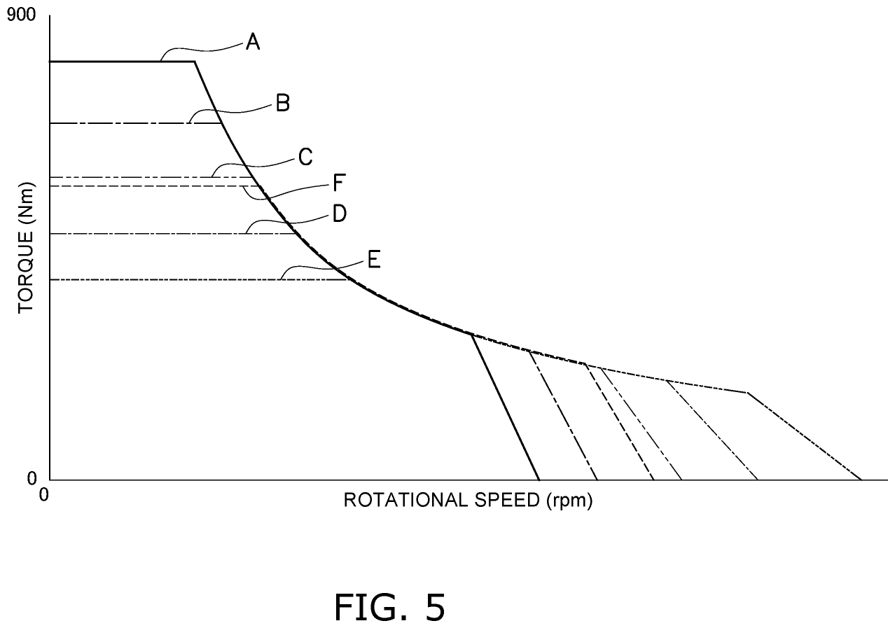

FIG. 5 is a chart showing a relation between rotational speed and torque outputted from the drive unit 100 in which the electric motor 2 and the transmission 4 are combined. In FIG. 5, a line A indicates characteristics exerted in selecting the first gear train 41; a line B indicates characteristics exerted in selecting the second gear train 42; a line C indicates characteristics exerted in selecting the third gear train 43; a line D indicates characteristics exerted in selecting the fourth gear train 44; a line E indicates characteristics exerted in selecting the fifth gear train 45. By contrast, a line F indicates characteristics of the electric motor to be used for the conventional electric car.

As shown in FIG. 5, the electric motor 2, combined with the transmission 4 in the drive unit 100, can make both the maximum speed and the maximum torque greater in magnitude than the electric motor in the conventional electric car.

### [Modifications]

One preferred embodiment of the present invention has been explained above. However, the present invention is not limited to the above, and a variety of changes can be made without departing from the gist of the present invention.

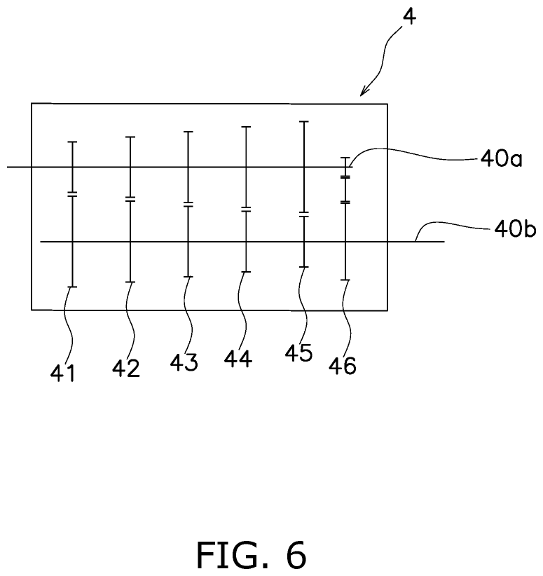

(a) In the preferred embodiment described above, the transmission 4 includes only the forward-rotation gear trains without including reverse-rotation gear trains; however, the configuration of the transmission 4 is not limited to this. For example, as shown in FIG. 6, the transmission 4 can include a reverse-rotation gear train 46. The reverse-rotation gear train 46 is greater in gear ratio than the first to fifth gear trains 41 to 45. In other words, the reverse-rotation gear train 46 is greater in gear ratio than the first gear train 41. When the electric motor 2 is rotated forward and the drive force thereof is outputted through the reverse-rotation gear train 46, the vehicle travels rearward.

(b) The drive unit 100 can further include a sound producing member. The sound producing member produces a sound when the electric motor 2 is rotated. For example, the sound producing member is rotated together with the electric motor 2 and produces a collision sound when colliding with a fixed member.

### REFERENCE SIGNS LIST

2: Electric motor
3: Clutch
15 4: Transmission
5: Controller
6: Electronic sound producing device
41: First gear train
42: Second gear train
20 43: Third gear train
44: Fourth gear train
45: Fifth gear train
46: Reverse-rotation gear train
100: Drive unit

What is claimed is:

1. A drive unit comprising:
an electric motor having characteristics that a maximum torque is less in magnitude than or equal in magnitude to two times a maximum output; and
a transmission configured to change a rotational speed of the electric motor at variable gear ratios.

2. The drive unit according to claim 1, further comprising
a clutch configured to transmit a mechanical power of the electric motor to the transmission, the clutch configured to block the mechanical power from being transmitted to the transmission.

3. The drive unit according to claim 2, wherein the clutch is a dry clutch.

4. The drive unit according to claim 2, wherein the clutch is of a solid type.

5. The drive unit according to claim 1, wherein the electric motor has a maximum rotational speed of less than or equal to 6000 rpm.

6. The drive unit according to claim 1, wherein the transmission has a gear ratio coverage of greater than or equal to 2.

7. The drive unit according to claim 1, wherein the transmission includes three or more gear trains.

8. The drive unit according to claim 7, further comprising
a controller configured to control the electric motor, wherein
the controller reversely rotates the electric motor in rearward traveling when determining that a gear train having a largest gear ratio is selected among the three or more gear trains.

9. The drive unit according to claim 1, further comprising
an electronic sound producing device configured to produce a sound in accordance with the rotational speed of the electric motor.

10. The drive unit according to claim 1, further comprising
a sound producing member configured to produce a sound when the electric motor is rotated.
